(19) United States
(12) Patent Application Publication
(10) Pub. No.: US 2011/0033231 A1
(43) Pub. Date: Feb. 10, 2011

(54) ASSEMBLY SYSTEM FOR CONNECTING FURNITURE ELEMENTS

(76) Inventor: Steen Sauer, Copenhagen (DK)

Correspondence Address: KLEIN, O'NEILL & SINGH, LLP, 18200 VON KARMAN AVENUE, SUITE 725, IRVINE, CA, 92612, US

(21) Appl. No.: 12/680,894

(22) PCT Filed: Oct. 12, 2007
(86) PCT No.: PCT/IB07/54163

§ 371 Date: Oct. 26, 2010

(30) Foreign Application Priority Data
Oct. 4, 2007 (DK) 2006 01282

(51) Int. Cl. F16B 21/02; B23P 17/04

(52) U.S. Cl. 403/348; 29/428

(57) ABSTRACT

The invention provides an assembly system for furniture. The assembly system comprises an elongated track (1) element which is attachable to a first furniture element and which defines a channel (3) extending in an axial direction, and a fitting element (2) with a first locking portion (4). The track element and fitting element cooperate to define three different orientations; an open mutual orientation wherein the first locking portion is allowed passage into and out of the channel, a closed mutual orientation wherein the first locking portion is movable in the axial direction within the channel, and a fixed mutual orientation wherein the first locking portion is locked immovably relative to the track element. The assembly system can replace traditional assembly sets comprising a large amount of screws, nails and the like, and thereby improve the assembling of furniture elements. Furthermore, the assembly system offers a simple way of assembling the furniture, merely by reorientation of the fitting element relative to the elongated track element, whereby the use of tools can be avoided.

### TECHNICAL FIELD

The present invention relates to an assembly system for furniture, e.g. for connecting elements of a piece of furniture such as cupboard elements and the like.

### BACKGROUND OF THE INVENTION

Furniture like cupboards, bookshelves, loudspeakers and the like often comprises plate shaped wall sections, top elements and bottom elements, which are connected along the edges and thereby form spatially shapes.

Since assembling of furniture requires different forms of tool and in some cases machinery, furniture is traditionally assembled at the factory where produced and subsequently delivered in an assembled state. Transportation, handling and storages of such spatially shaped furniture require a great deal of space compared to non-assembled furniture elements, not least for furniture shops and end-users.

Therefore, attempts have been made to deliver non-assembled furniture elements which have to be assembled at the place of use. When the end-user receives the furniture, it is typically packed with a set of assembly elements which often comprises a large amount of screws, nails, and similar assembly features. First, the user has to get an overview of the large amount of pieces received. Subsequently, each piece has to be fastened correctly often by use of different tools. It often happens that pieces are mixed up so that assembling of the furniture elements has to be redone, or alternatively that the user has to live with a defective, and possibly unstable and lopsided furniture.

### SUMMARY OF THE INVENTION

It is an object of embodiments of the present invention to provide an improved assembly system for connecting furniture elements.

In a first aspect, the invention provides an assembly system for furniture, the system comprising: an elongated track element which is attachable to a first furniture element and which defines a channel extending in an axial direction, and a fitting element with a first locking portion, the elongated track element and fitting element cooperating to define: an open mutual orientation wherein the first locking portion is allowed passage into and out of the channel, a closed mutual orientation wherein the first locking portion is movable in the axial direction within the channel, and a fixed mutual orientation wherein the first locking portion is locked immovably relative to the elongated track element.

The system offers a simple way of assembling the furniture, merely by reorientation of the fitting element relative to the elongated track element, whereby the use of tools can be avoided.

The elongated track element may be attached to the first furniture element at the factory where the furniture elements are produced. A plurality of elongated track elements may be attached to each of the first furniture elements, e.g. by providing a set of elongated track elements in parallel at a surface of the first furniture element. The elongated track element may be countersunk in a surface of the first furniture element. To provide a plane surface, an upper surface of the elongated track element may form part of the furniture surface whereby the channel may extend in the first furniture element below the surface of the first furniture element. To countersink the elongated track element in the surface of the first furniture element, the first furniture element may be provided with an elongated groove with a cross sectional shape which matches the cross sectional shape of the elongated track element so that an inner surface of the groove is in contact with an outer surface of the elongated track element when the elongated track element is located in the groove.

The elongated track element can be attached adhesively to the first furniture element, or the elongated track element may be interlocked in a groove in the surface by providing a cross sectional shape of the elongated track element which cooperates with a cross sectional shape of the groove, e.g. to form a dovetail joint, or the elongated track element may be attached by nails, screws, rivets, etc. Alternatively or additionally, the outer surface of the elongated track element may have a frictional coefficient which reduces or prevents sliding of the elongated track element in the groove of the first furniture element. In one embodiment, protrusions may be provided at the outer surface of the elongated track element to engage the inner surface of the groove. The elongated track element may be formed of metal, e.g. aluminium, of plastic or of other materials, e.g. by an extrusion process.

The elongated track element may comprise a flange portion defining an opening into the channel and which allows passage of the first locking portion into the channel in the open mutual orientation and which prevents movement of the first locking portion out of the channel in the closed mutual orientation.

To enable assembling of several furniture elements, the fitting element may further comprise a second locking portion adapted to retain a second furniture element.

In the open mutual orientation, the first locking portion is allowed passage into and out of the channel, e.g. by turning the fitting element 90 degrees relative to the direction of use and then inserting the first locking portion into the channel. In the closed mutual orientation, the fitting element may be attached to the elongated track element, e.g. by turning the fitting element 90 degrees whereby the first locking portion may be locked in the channel by the flange portion. In the closed mutual orientation, the first locking portion is moveable in the axial direction within the channel. In the fixed mutual orientation, the first locking portion is locked immovably relative to the elongated track element.

The fitting element may in the fixed mutual orientation form an essentially plane surface portion which is in level with the upper surface of the elongated track element. The first locking portion may be provided as a T-shaped portion with a transverse portion extending perpendicularly to a main portion. The main portion may be shaped so that it extends in the axial direction when the fitting element is in the fixed mutual orientation. The second locking portion may form a protrusion extending from the plane surface portion of the fitting element, e.g. extending perpendicular to the plane surface portion.

The first furniture element may e.g. be a sidewall element or a back wall element of a cupboard or the like, whereas the second furniture element may be a shelf element, a top element, a bottom element, a door element, etc. Thus, the assembly system comprising the elongated track element and the fitting element may be used for joining a cupboard and the like. The assembly system may comprise different types of fitting elements for the same type of elongated track element. As an example, one fitting element may be suitable for a shelf element, whereas another type of fitting element may be suitable for a door element, both types of fitting elements being suitable for the same elongated track element, e.g. an elongated track element which may be attached to a first furniture element in the form of a sidewall element.

When the sidewall elements, with the countersunk elongated track elements have been produced at a factory, they could be packed together with a top element and a bottom element and possibly a number of shelf elements. The top element and the bottom element may be formed with depressions or holes for receiving the second locking portion of the fitting element. In a similar manner, the shelf elements could be provided with depressions or holes. A number of fitting elements may be located in the package and the package can be shipped to a buyer. The fitting elements may e.g. be completely identical elements which are all provided with a first locking portion which can enter the channel in the elongated track element and be fixated therein. They may further comprise a second locking portion which can engage a depression or hole in the top and bottom elements or in the shelf elements. The fitting elements may also have different second locking portions. One group of the fitting elements may have a second locking portion which is adapted to engage the depressions or holes in the top and bottom elements. This second locking portion may in some embodiments form an upwardly extending protrusion with a conically shaped outer surface which can enter into the depressions or holes and which thereby pulls the top or bottom element towards the sidewall element. Another group of the fitting elements may have a second locking portion which can be attached e.g. to a hinge for supporting a door, or the second locking portion may simply serve to be attached to any kind of elements, e.g. by providing a body in which a screw or nail may be fastened.

When the package is received, the user may attach the fitting elements at various places along the elongated track elements by inserting the first locking portion in the channel and by reorienting the fitting element until it is locked in a fixed position relative to the elongated track element. Subsequently, the user may connect the top and bottom elements and optionally the shelf elements without using any tools. If all the fitting elements are identical, almost nothing can go wrong, and if the fitting elements are different, it is not very critical if the user locates them wrongly in the first attempt. The fitting elements will just have to be reoriented in the opposite sequence until the element can be removed from the elongated track element to be repositioned at a new location.

In order to prevent movement of the fitting element in the axial direction when the fitting element and the elongated track element define the fixed mutual orientation, the fitting element and elongated track element may comprise locking features adapted to cooperate.

The invention may provide a flexible assembly system according to which the locking features may provide a plurality of locking positions along the axial direction of the elongated track element. At these locking positions, movement of the fitting element may be prevented, and the fitting element may be positioned optionally at one of the locking positions. Providing a plurality of locking positions along the elongated track element may furthermore allow for the use of a plurality of fitting elements in combination with each elongated track element, whereby a first furniture element may be connected to a plurality of second furniture elements. As an example, a first furniture element in the form of a sidewall element or a back wall element may be connected to a plurality of second furniture elements in the form of shelf elements and may further be connected to a top element and to a bottom element, each element being connected via a fitting element at a locking portion along the axial direction.

In order to fixate the fitting element in the elongated track element, the locking features of the fitting element may comprise protrusions adapted to engage corresponding cavities in the channel.

Alternatively or additionally, the locking features may comprise an indented surface of one of the fitting element and the elongated track element arranged to engage a projection or indentation in the other one of the fitting element and elongated track element. The projection or indentation may in some embodiments form part of an indented surface of the other part.

In some embodiments, the channel may form end portions on opposite side of an intermediate portion in a cross section perpendicular to the axial direction. The end portions may extend towards an opening into the channel, whereby the end portions may define the flange portion.

The elongated track element may define a channel which is open at both ends. These open ends may be closed using end stops. The fitting element may form these end stops.

In a simple embodiment, the channel may form a quadrangular shape in a cross section perpendicular to the axial direction. The channel may thus comprise a front wall, a rear wall and two sidewalls. The opening may be formed in the front wall. In this embodiment, the front wall and rear wall may be essentially parallel, and the sidewalls may be essentially parallel. Furthermore, the front and rear walls may be perpendicular to the sidewalls.

The cavities, which may be part of the locking features, may be formed in the rear wall of the channel. Alternatively or additionally, the cavities may be formed in the sidewalls or the front wall. The locking features of the fitting element may be positioned in order to fit into these cavities. If the cavities are formed in the rear wall of the channel, the protrusions of the fitting element may be formed at the backside of the main portion.

In some embodiments, the second locking portion may be formed to engage a depression or a hole of the second furniture element, whereby the second locking portion may be hidden when the first and second furniture elements are connected.

The fitting element may be shaped to reduce the distance between the first and second furniture elements when the second locking portion engages the depression or hole of the second furniture element. As an example, the second locking portion may comprise a protrusion having a conically shaped upper part, allowing the fitting element to attract the second furniture element when this element is attached to the second locking portion.

In some embodiments, the fitting element may be used in connection with hinges and the like. As an example, the second locking portion may be connected to a hinge in order to support a door element. One part of the hinge may be connected to cavities provided at the front side of the second locking portion, while the other part of the hinge may be connected to a door element for a piece of furniture, e.g. for a cupboard.

In a second aspect, the invention provides a piece of furniture with at least a first furniture element and a second furniture element, the furniture elements being connected by an assembly system, said assembly system comprising: an elongated track element attached to the first furniture element, which elongated track element defines a channel extending in an axial direction, and a fitting element with a first locking portion, the elongated track element and fitting element cooperating to define: an open mutual orientation wherein the first locking portion is allowed passage into and out of the channel, a closed mutual orientation wherein the first locking portion is movable in the axial direction within the channel, and a fixed mutual orientation wherein the first locking portion is locked immovably relative to the elongated track element. It should be understood, that the furniture may comprise any feature relating to the first aspect.

In a third aspect, the invention provides an assembly for making furniture, the assembly comprising at least one furniture element fitted with an elongated track element of the kind described already and being attached to the furniture element. The assembly further comprises at least one of the fitting elements already described and at least one additional furniture element to be joined to the other furniture element via the fitting element.

In a fourth aspect, the invention provides a method of assembling a piece of furniture from at least two furniture elements, one of which being provided with an elongated track element of the kind already described and the other furniture element being provided with a feature which cooperate with a fitting element of the kind already described. The method comprising the steps of: Inserting the first locking portion into the channel of the elongated track element, reorienting the fitting element in the channel, and attaching the other furniture element to the fitting element.

### BRIEF DESCRIPTION OF THE DRAWINGS

Embodiments of the invention will now be further described with reference to the drawings, in which:

FIGS. 1-1a show a first embodiment of an elongated track element,

FIGS. 2-3 show a first embodiment of a fitting element,

FIGS. 4-6 show the fitting element of FIGS. 2 and 3 and an embodiment of an elongated track element,

FIGS. 7-8 show a second embodiment of a fitting element,

FIGS. 9-12 show the fitting element of FIGS. 7 and 8 and an embodiment of an elongated track element,

FIG. 13 shows a third embodiment of a fitting element, and

FIGS. 14-15 show a second embodiment of an elongated track element.

### DETAILED DESCRIPTION OF THE DRAWINGS

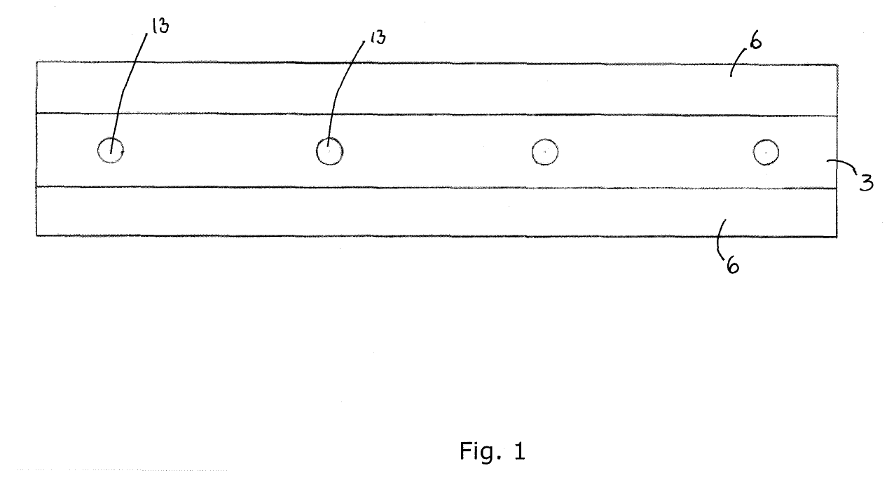

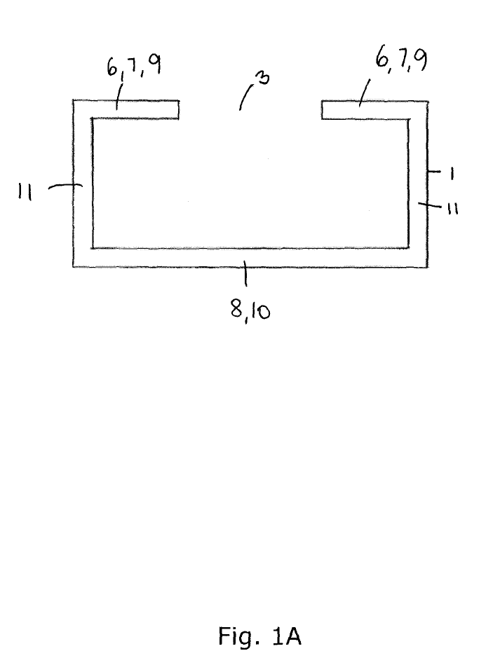

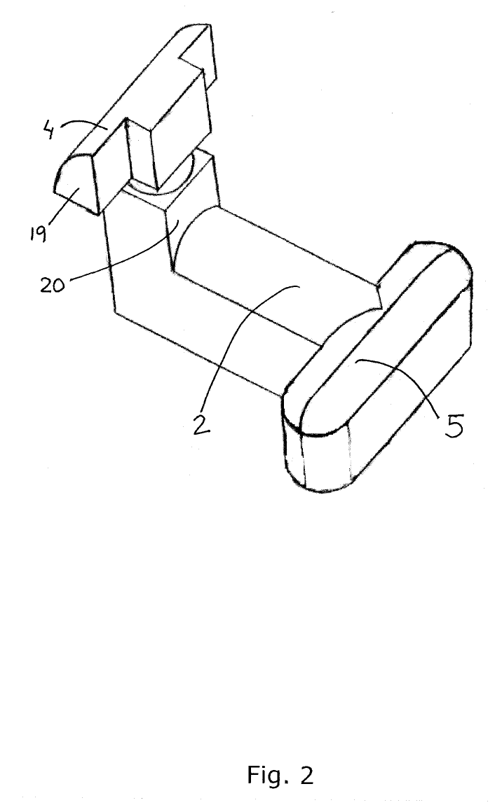

FIGS. 1 and 2 show an example of an elongated track element 1 (FIG. 1) and an example of a fitting element 2 (FIG. 2) for connecting a first and a second furniture element. The elongated track element 1 is attachable to the first furniture element and defines a channel 3 extending in the axial direction. The fitting element 2 has a first locking portion 4 and a second locking portion 5. The channel 3 comprises a flange portion 6 allowing passage of the first locking portion 4 into and out of the channel 3. Furthermore, the configuration of the flange portion 6 and the locking portion 4 prevent movement of the first locking portion 4 out of the channel 3 in a closed mutual orientation, in which orientation the first locking portion 4 is movably in the axial direction within the channel 3.

The first furniture element may e.g. be a sidewall element or a back wall element of a cupboard, whereas the second furniture element may be a shelf element, a top element, a bottom element or a door element so that the assembly system comprising the elongated track element 1 and the fitting element 2 may be used for joining cupboard elements.

In a cross section perpendicular to the axial direction (see FIG. 1a), the channel 3 forms end portions 7 on opposite side of an intermediate portion 8. The end portions 7 extend towards an opening into the channel 3. In the embodiment shown in FIGS. 1 and 1a, the channel 3 forms a quadrangular shape with a front wall 9, a rear wall 10 and two sidewalls 11 in a cross section perpendicular to the axial direction. Thus, the opening in the channel 3 is formed in the front wall 9. In this embodiment, the front wall 9 comprises the end portions 7 and the rear wall comprises the intermediate portion 8. Furthermore, this embodiment comprises a front wall 9 and a rear wall 10, which are essentially parallel, and 10 sidewalls 11 also being essentially parallel. Due to the quadrangular shape of the channel of this embodiment, the front and rear walls 9, 10 are essentially perpendicular to the sidewalls 11.

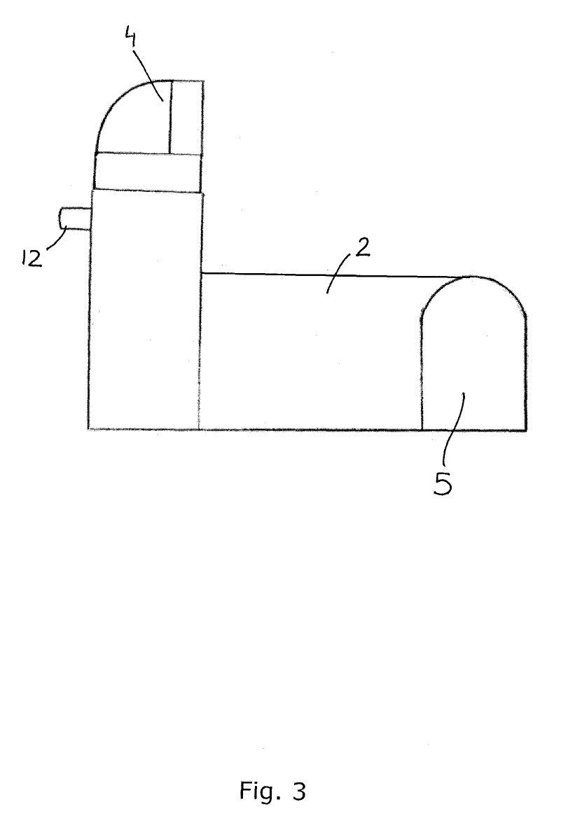

FIG. 3 shows the fitting element 2 shown in FIG. 2 in a different view.

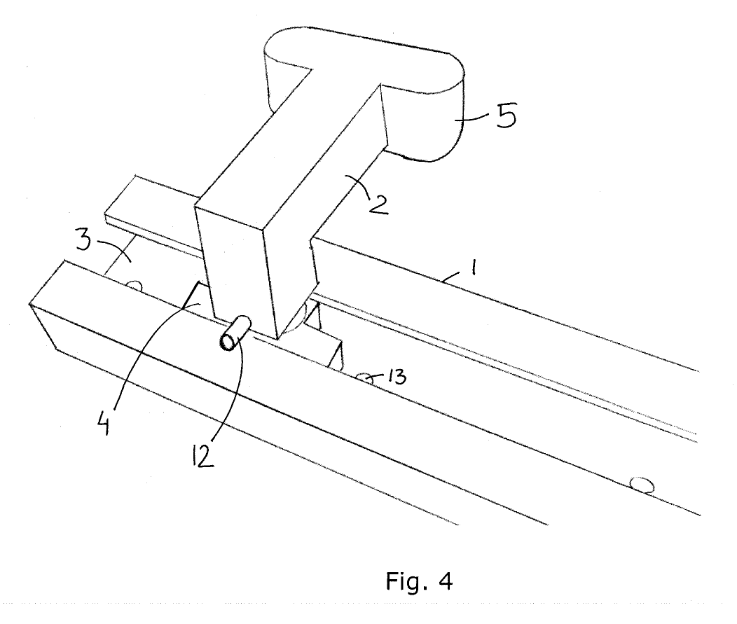

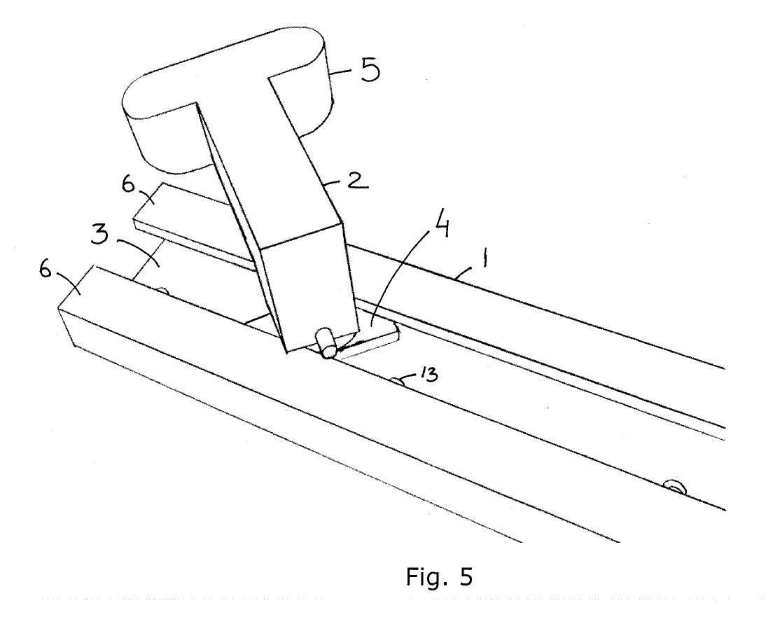

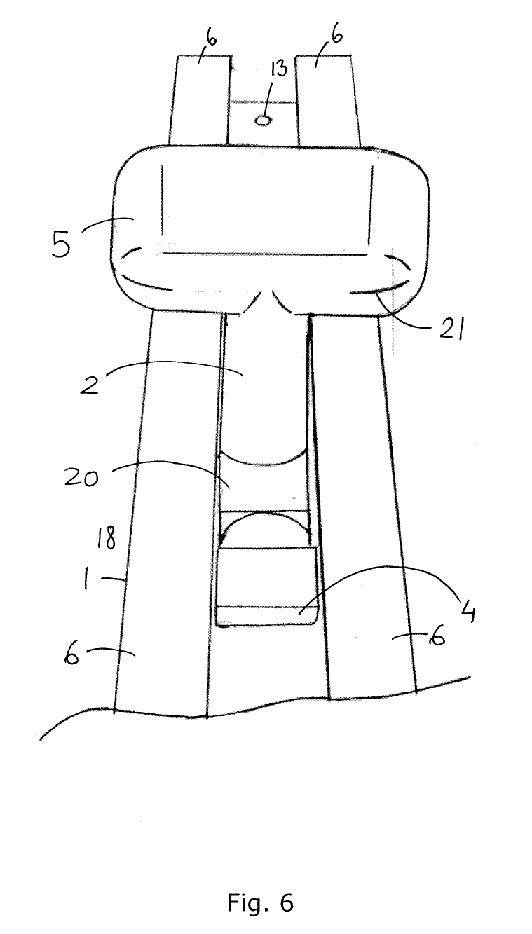

FIGS. 4-6 show the elongated track element 1 and the fitting element 2 cooperating to define different orientations. In the open mutual orientation, the first locking portion 4 is allowed passage into and out of the channel 3, which orientation can be seen in FIG. 4. FIG. 5 shows how the fitting element 2 is turned, while the first locking porting 4 is in the channel 3. When the fitting element 2 is turned 90 degrees around an axis perpendicular to the axial direction, the fitting element 2 and the elongated track element 1 define a closed mutual orientation (not shown), where the first locking portion 4 is movable in the axial direction within the channel 3. FIG. 6 shows the fixed mutual orientation, in which orientation the first locking portion 4 is locked immovably relative to the elongated track element 1. When locking the first locking portion 4 immovably, the fitting element 2 is tilted 90 degrees along the axial direction and possibly lifted upwards or pushed downwards to ensure cooperation between locking features 12, 13.

In order to lock the fitting element 2 immovably relative to the elongated track element 1, the fitting element 2 and elongated track element 1 comprise locking features 12, 13 cooperating to prevent movement of the fitting element 2 in the axial direction when the elongated track element 1 and the filling element 2 cooperates to define the fixed mutual orientation. These locking features 12, 13 provide a plurality of locking positions at the elongated track element 1 along the axial direction. As shown in FIGS. 3-5, the locking features of the fitting element 2 comprise protrusions 12 adapted to engage corresponding cavities 13 in the channel 3 in order to fixate the fitting element 2 in the elongated track element 1. The corresponding cavities 13 being formed in the rear wall 10 are shown in FIG. 1. The cavities 13 are positioned with a predetermined distance along the whole length of the elongated track element 1 in order to be able to lock the fitting element 2 at a plurality of locking positions, and in order to be able to attach a plurality of fitting elements 2 to the elongated track element 1.

As shown in FIG. 6, the fitting element 2 forms an essentially plane surface portion 17 when the first locking portion 4 is locked immovably relative to the elongated track element 1, which plane surface portion 17 is in level with the upper surface 18 of the elongated track element 1. The first locking portion 4 is provided as a T-shaped portion with a transverse portion 19 extending perpendicularly to a main portion 20 (see FIG. 2). In this position, the main portion 20 is shaped so that it extends in the axial direction. The second locking portion 5 has a protrusion with a conically shaped upper surface 21, which protrusion extends perpendicular to the plane surface portion 17 of the fitting element 2.

As shown in FIGS. 2-6, this embodiment of the fitting element 2 comprises a second locking portion 5 which is formed to engage a depression or hole at the second furniture element, e.g. a shelf element or a bottom element. The second locking portion 5 comprises a protrusion with a conically shaped upper surface 21, whereby the distance between the first furniture element, e.g. a sidewall element of a cupboard, and the second furniture element, e.g. a shelf element, may be reduced when the second locking portion 5 engages the depression or hole of the second furniture element. The elongated track element 1 may be countersunk into the first furniture element in order to reduce the distance between the furniture elements even further.

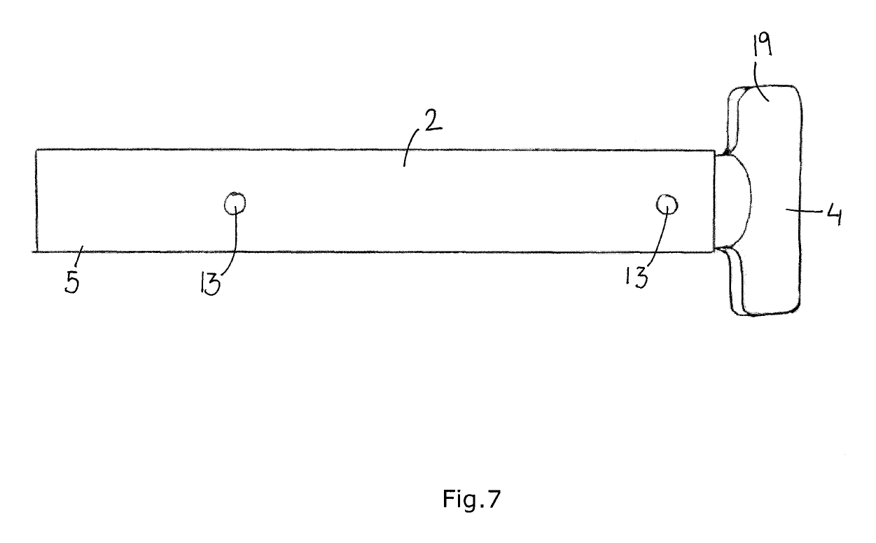

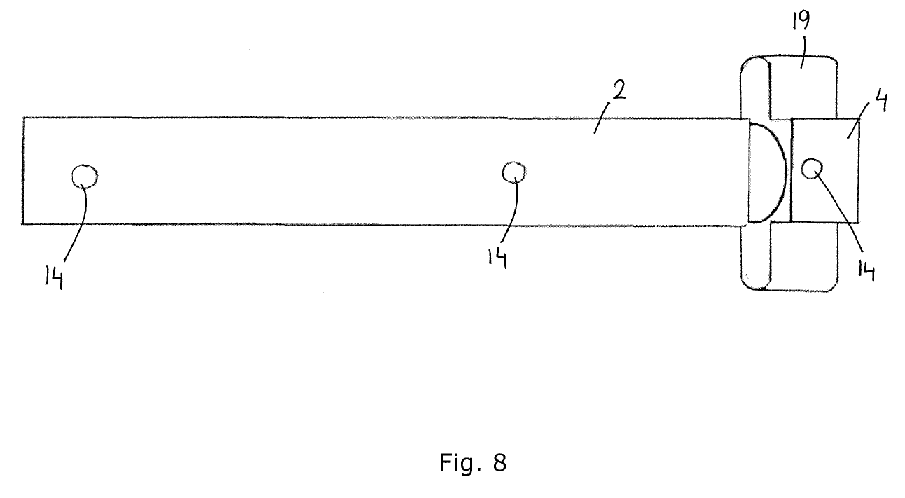

FIGS. 7-8 show a second embodiment of a fitting element 2 according to the invention. The second locking portion 5 of this embodiment is elongated and therefore not formed to engage a depression or hole of the second furniture element. Instead, the second locking portion 5 comprises hinge cavities 14 at the front side (see FIG. 8). These hinge cavities 14 may be use to attach a hinge to the fitting element 2 by screws which are screwed into the hinge cavities 14. The other part of the hinge may be attached to a second furniture element in the form of e.g. a door element, whereby this embodiment of a fitting element 2 together with an elongated track element 1 may be used to connect a first furniture element in the form of a sidewall element and a second furniture element in the form of a door element, or drawer system etc.

At the backside (see FIG. 7), the fitting element 2 comprises locking features in the form of protrusions 12 adapted to engage corresponding cavities 13 at the elongated track element 1 (see FIG. 1). The first locking portion 4 of this embodiment of a fitting element 2 is identical to the first locking portion 4 of the first embodiment of a fitting element 1 as shown in FIGS. 2-3.

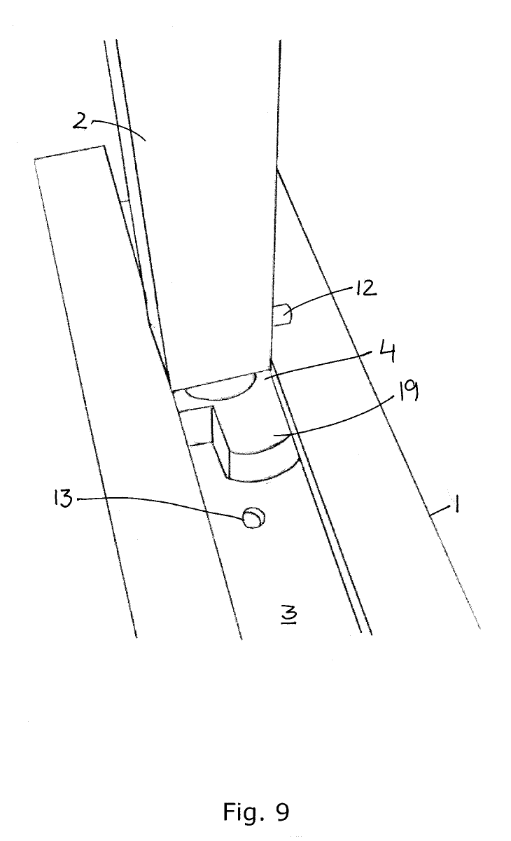

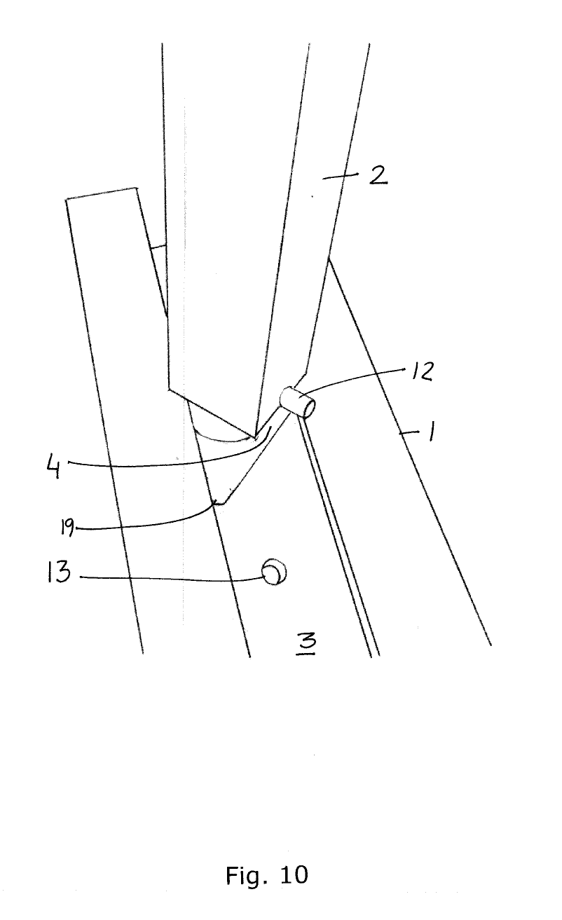

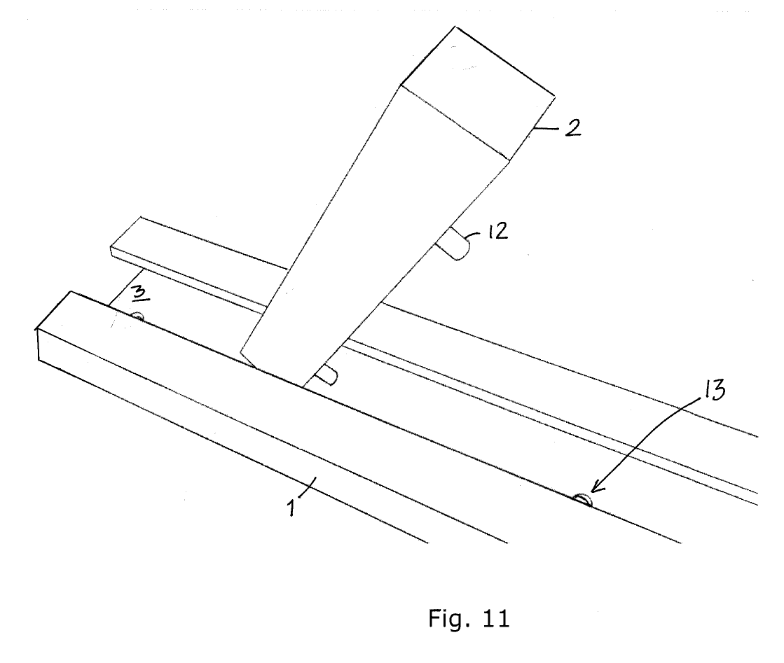

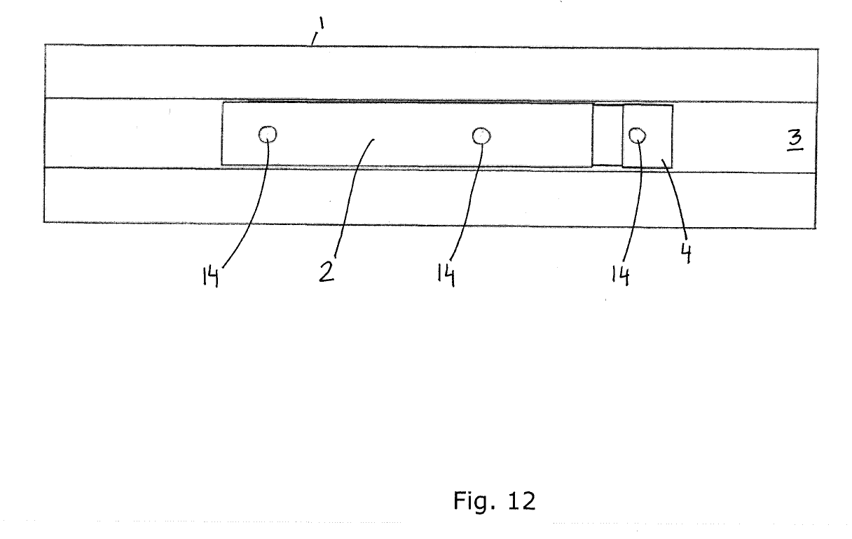

FIGS. 9-12 show that the second embodiment of the fitting element 2 and the elongated track element 1 also cooperate to define different orientations. In the open mutual orientation, the first locking portion 4 is allowed passage into and out of the channel 3, which orientation can be seen in FIG. 9. FIG. 10 shows how the fitting element 2 is turned, the first locking porting 4 being in the channel 3. When the fitting element 2 is turned 90 degrees around an axis perpendicular to the axial direction, the first locking portion 4 is in the closed mutual orientation (not shown), where the first locking portion 4 is moveable in the axial direction within the channel 3. FIG. 11 shows how the fitting element 2 is tilted 90 degrees along the axial direction in order to lock the first locking portion 4 immovably relative to the elongated track element 1. The fitting element 2 may possibly be lifted upwards or pushed downwards in connection with the tilting thereof in order to ensure cooperation between the locking features 12, 13. FIG. 12 shows the fixed mutual orientation, in which the first locking portion 4 is locked immovably.

As shown in the above-described FIGS. 1-12, the two different embodiments of the fitting element 2 are adapted to for the same type of elongated track element 1, whereby the assembly system is flexible and easy to use. The elongated track element 1 may be countersunk in a sidewall element or a back wall element of cupboard (a first furniture element) and depending on the type of second furniture element (a shelf element, a top element, a bottom element, a door element, etc.), the applicable embodiment of a fitting element 2 may be chosen.

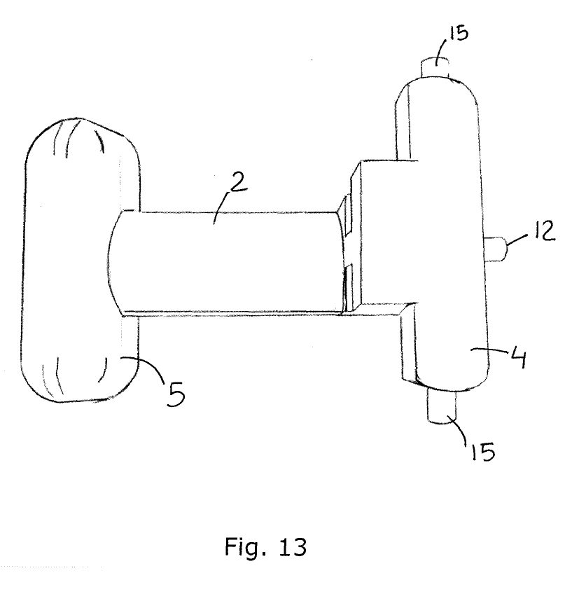

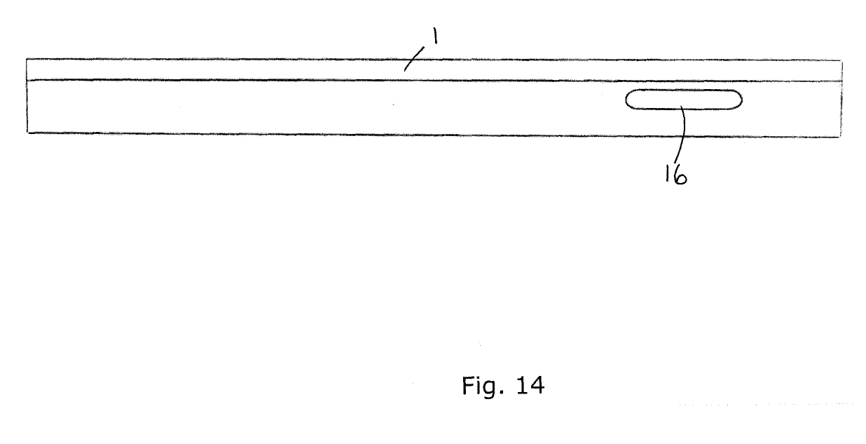

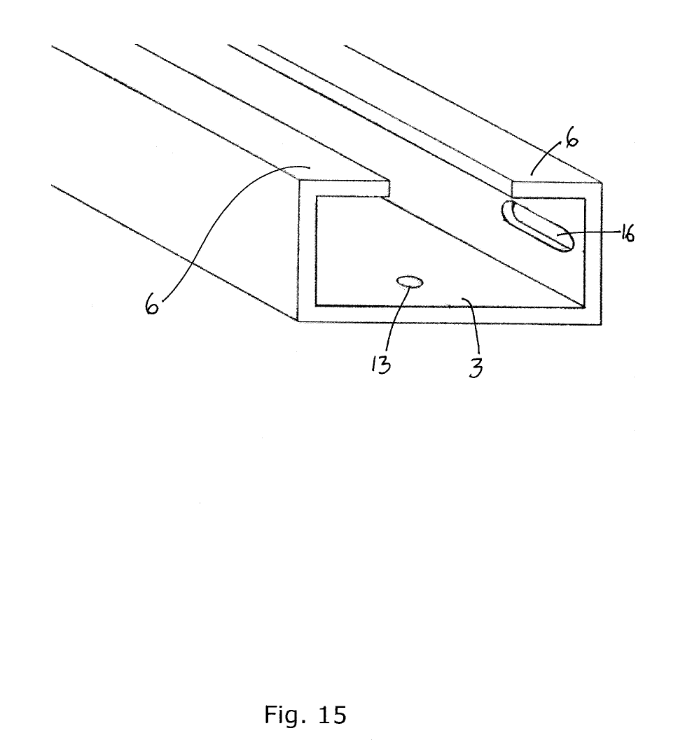

FIG. 13 shows a third embodiment of a fitting element 2 according to the present invention. In this embodiment, the first locking portion 4 comprises additional locking features in the form of sideways extending protrusions 15. These sideways extending protrusions 15 are adapted to engage corresponding side cavities 16 in the sidewall 11 of the channel 3, see FIGS. 14-15. The side cavities 16 are elongated cavities in order to be able to turn the fitting element 2 90 degrees around an axis perpendicular to the axial direction, and thereby be able to rotate it from the open mutual orientation to the closed mutual orientation.

1. An assembly system for furniture, the system comprising:
an elongated track element which is attachable to a first furniture element and which defines a channel extending in an axial direction, and
a fitting element with a first locking portion. the elongated track element and fitting element cooperating to define:
an open mutual orientation, wherein the first locking portion is allowed passage into and out of the channel,
a closed mutual orientation, wherein the first locking portion is movable in the axial direction within the channel, and
a fixed mutual orientation, wherein the first locking portion is locked immovably relative to the elongated track element.

2. An assembly system according to claim 1, wherein the elongated track element comprises a flange portion defining an opening into the channel and allowing passage of the first locking portion into the channel in the open mutual orientation and which prevents movement of the first locking portion out of the channel in the closed mutual orientation.

3. An assembly system according to claim 1, wherein the fitting element further comprises a second locking portion adapted to retain a second furniture element.

4. An assembly system according to claim 1, wherein the fitting element and elongated track element comprise locking features cooperating to prevent movement of the fitting element in the axial direction when the fitting element and the elongated track element define the fixed mutual orientation.

5. An assembly system according to claim 4, wherein the locking features provide a plurality of locking positions at the elongated track element along the axial direction, at which locking positions movement of the fitting element is prevented.

6. An assembly system according to claim 4, wherein the locking features of the fitting element comprise protrusions adapted to engage corresponding cavities in the channel to fixate the fitting element in the elongated track element.

7. An assembly system according to claim 4, wherein the locking features comprise an indented surface of one of the fitting element and the elongated track element arranged to engage a projection or indentation in the other one of the fitting element and elongated track element.

8. An assembly system according to claim 1, wherein the channel in across section perpendicular to the axial direction forms end portions on opposite side of an intermediate portion, the end portions extending towards an opening into the channel.

9. An assembly system according to claim 8, wherein the channel in across section perpendicular to the axial direction forms an quadrangular shape with a front wall, a rear wall and two sidewalls, the opening being formed in the front wall.

10. An assembly system according to claim 9, wherein the front wall and rear wall are essentially parallel.

11. An assembly system according to claim 9, wherein the sidewalls are essentially parallel.

12. An assembly system according to claim 9, wherein the front and rear walls are perpendicular to the sidewalls.

13. An assembly system according to claim 6, wherein the cavities are formed in the rear wall.

14. An assembly system according to claim 3, wherein the second locking portion is formed to engage a depression of the second furniture element.

15. An assembly system according to claim 14, wherein the fitting element is shaped to reduce the distance between the first and second furniture elements when the second locking portion engages the depression.

16. An assembly system according to claim 1, wherein the second locking portion is connected to a hinge to support a door element.

17. A piece of furniture with at least a first furniture element and a second furniture element, the furniture elements being connected by an assembly system, said assembly system comprising:
an elongated track element attached to the first furniture element, which elongated track element defines a channel extending in an axial direction, and
a fitting element with a first locking portion, the elongated track element and fitting element cooperating to define:
an open mutual orientation, wherein the first locking portion is allowed passage into and out of the channel,
a closed mutual orientation, wherein the first locking portion is movable in the axial direction within the channel, and
a fixed mutual orientation, wherein the first locking portion is locked immovably relative to the elongated track element.

18. An assembly for making furniture, the assembly comprising:
at least one furniture element comprising an elongated track element which defines a channel extending in an axial direction,
at least one fitting element with a first locking portion, and
at least one additional furniture element to be joined to the other furniture element via the fitting element, the elongated track element and fitting element cooperating to define:
an open mutual orientation, wherein the first locking portion is allowed passage into and out of the channel,
a closed mutual orientation, wherein the first locking portion is movable in the axial direction within the channel, and
a fixed mutual orientation, wherein the first locking portion is locked immovably relative to the elongated track element.

19. A method of assembling a piece of furniture from at least two furniture elements, one of which being provided with an elongated track element which defines a channel extending in the axial direction and the other furniture element being provided with a feature which cooperate with a fitting element with a first locking portion, he elongated track element and fitting element cooperating to define:
an open mutual orientation, wherein the first locking portion is allowed passage into and out of the channel,
a closed mutual orientation, wherein the first locking portion is movable in the axial direction within the channel, and
a fixed mutual orientation, wherein the first locking portion is locked immovably relative to the elongated track element, the method comprising the steps of:
inserting the first locking portion into the channel of the elongated track element,
reorienting the fitting element in the channel, and
attaching the other furniture element to the fitting element.
